(19) United States
(12) Patent Application Publication
(10) Pub. No.: US 2025/0292293 A1
(43) Pub. Date: Sep. 18, 2025

(54) MOVING COST ESTIMATOR

(71) Applicant: INTERNATIONAL BUSINESS MACHINES CORPORATION, ARMONK, NY (US)

(72) Inventor: Tyler Waite, Lake Washington, WA (US)

(21) Appl. No.: 18/607,877

(22) Filed: Mar. 18, 2024

(51) Int. Cl. G06Q 30/0283; G06Q 10/30; G06Q 30/0601; G06V 20/00

(52) U.S. Cl. CPC G06Q 30/0283; G06Q 10/30; G06Q 30/0629; G06Q 30/0631; G06V 20/00

(57) ABSTRACT

A method for item-specific moving recommendations. The method receives a current location and a destination location. The method further receives a plurality of images of a living space in the current location and analyzes the plurality of images using computer vision analysis to identify one or more items. The method determines a first cost to move the one or more identified items from the current location to the destination location and a second cost to forego moving the one or more identified items and replacing them. In response to determining that the first cost exceeds the second cost, the method generates a recommendation to forego moving the one or more identified items and replacing them. In response to determining that the first cost is less than the second cost, the method generates a recommendation to move the one or more identified items from the current location to the destination location.

### BACKGROUND

The present disclosure relates generally to the field of cognitive computing and more particularly to data processing and computer vision analysis using artificial intelligence (AI).

Relocating to a new house or apartment can be a stressful and time-consuming event. The moving process involves packing up all personal belongings and transporting these items to a new location. Oftentimes, it may be more economical to get rid of some of the old possessions and purchase new ones. For example, the cost to move an old raggedy couch may cost more than the couch itself. Additionally, the distance of the move may also affect moving costs.

For many people, knowing which items to keep and which to get rid of, when moving, can be a difficult task. Additionally, knowing the value of the items one owns can also be a difficult task, especially when there are years of wear and tear. As such, selling personal items can be frustrating and time consuming.

Nowadays, moving cost estimation websites typically only ask for house size, origination information, and destination information when compiling a moving estimate. The cost of moving may be less expensive if people sell, donate, or get rid of items they own and purchase new replacement items in the area they are moving to.

### BRIEF SUMMARY

Embodiments of the present invention disclose a method, a computer program product, and a system.

According to an embodiment, a method, in a data processing system including a processor and a memory, for item-specific moving recommendations. The method receives a current location and a destination location. The method further receives a plurality of images of a living space in the current location and analyzes the plurality of images using computer vision analysis to identify one or more items, in the plurality of images, belonging to a user. The method calculates a respective value of the one or more identified items in the plurality of images and determines a first cost to move the one or more identified items from the current location to the destination location and a second cost to forego moving the one or more identified items and replacing the one or more identified items. In response to determining that the first cost exceeds the second cost, the method generates a recommendation to forego moving the one or more identified items and replacing the one or more identified items. In response to determining that the first cost is less than the second cost, the method generates a recommendation to move the one or more identified items from the current location to the destination location.

A computer program product, according to an embodiment of the invention, includes a non-transitory tangible storage device having program code embodied therewith. The program code is executable by a processor of a computer to perform a method. The method receives a current location and a destination location. The method further receives a plurality of images of a living space in the current location and analyzes the plurality of images using computer vision analysis to identify one or more items, in the plurality of images, belonging to a user. The method calculates a respective value of the one or more identified items in the plurality of images and determines a first cost to move the one or more identified items from the current location to the destination location and a second cost to forego moving the one or more identified items and replacing the one or more identified items. In response to determining that the first cost exceeds the second cost, the method generates a recommendation to forego moving the one or more identified items and replacing the one or more identified items. In response to determining that the first cost is less than the second cost, the method generates a recommendation to move the one or more identified items from the current location to the destination location.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method receives a current location and a destination location. The method further receives a plurality of images of a living space in the current location and analyzes the plurality of images using computer vision analysis to identify one or more items, in the plurality of images, belonging to a user. The method calculates a respective value of the one or more identified items in the plurality of images and determines a first cost to move the one or more identified items from the current location to the destination location and a second cost to forego moving the one or more identified items and replacing the one or more identified items. In response to determining that the first cost exceeds the second cost, the method generates a recommendation to forego moving the one or more identified items and replacing the one or more identified items. In response to determining that the first cost is less than the second cost, the method generates a recommendation to move the one or more identified items from the current location to the destination location.

### BRIEF DESCRIPTION OF THE DRAWINGS

FIG. 1 depicts a diagram graphically illustrating the hardware components of a computing environment 100, such as moving cost estimator computing environment 200, and a cloud computing environment, in accordance with an embodiment of the present invention.

FIG. 2 illustrates moving cost estimator computing environment 200, in accordance with an embodiment of the present invention.

FIG. 3 is a flowchart illustrating the operation of moving cost estimator program 220 of FIG. 2, in accordance with an embodiment of the present invention.

### DETAILED DESCRIPTION

In today's technology-driven world, deciding what to sell, what to keep, and what to trash when considering moving expenses can be made much simpler and easier.

The current invention utilizes a user-friendly interface that provides options for a user to decide what to do with each personal item. For example, will a user keep their old bedframe or try to sell it and save on moving expenses? Determining a value for each personal item, especially used items, can be a daunting task for any layperson. The research and effort required to fix a price and sell items can be outright time-consuming.

The disclosed invention uses digital photographs, or three-dimensional (3D) models and computer vision to help users quickly assess the value of their belongings and connects them to services that can help them move, sell, donate, or otherwise dispose of their belongings.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

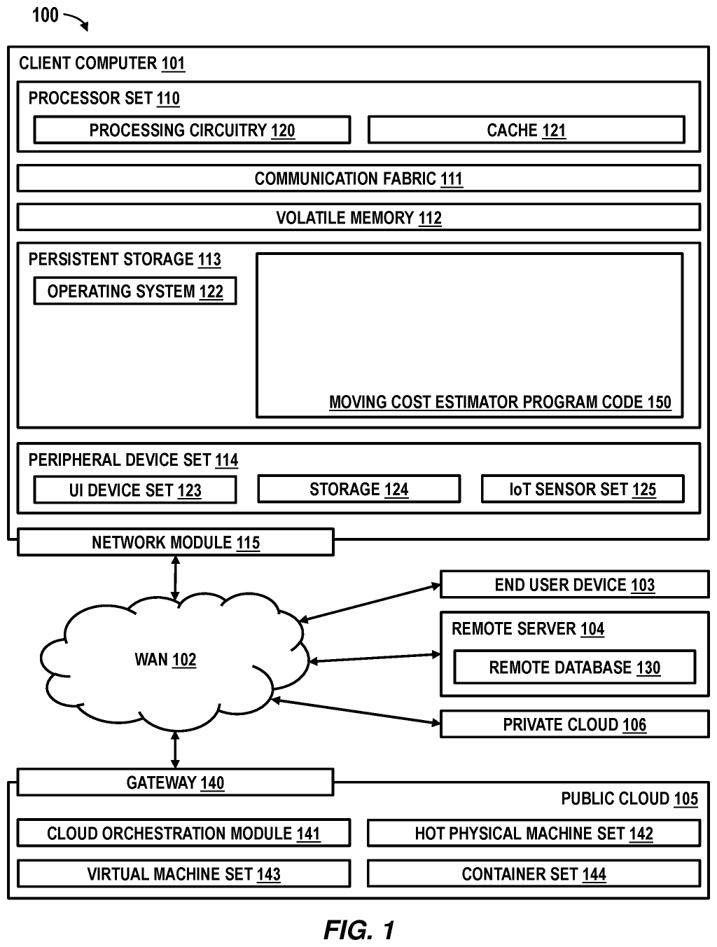

FIG. 1 depicts a diagram graphically illustrating the hardware components of a computing environment 100, such as moving cost estimator computing environment 200, and a cloud computing environment in accordance with an embodiment of the present invention.

Computing environment 100 contains an example of an environment for the execution of at least some of the computer code involved in performing the inventive methods, such as moving cost estimator program code 150. In addition to the moving cost estimator program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and moving cost estimator program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in moving cost estimator program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in moving cost estimator program code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

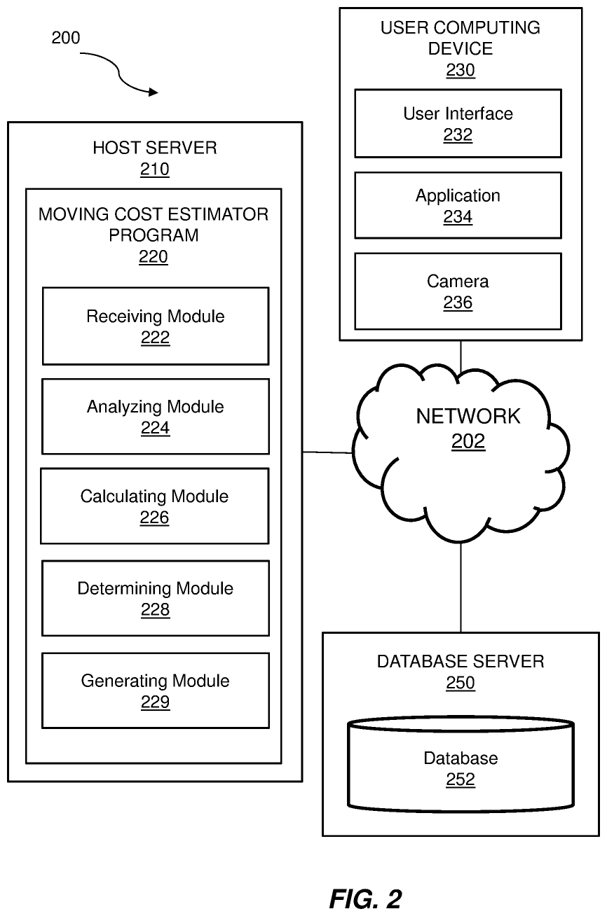

FIG. 2 illustrates moving cost estimator computing environment 200, in accordance with an embodiment of the present invention. Moving cost estimator computing environment 200 includes host server 210, user computing device 230, and database server 250, all connected via network 202. The setup in FIG. 2 represents an example embodiment configuration for the present invention and is not limited to the depicted setup to derive benefit from the present invention.

In an exemplary embodiment, host server 210 includes moving cost estimator program 220. In various embodiments, host server 210 may be a laptop computer, tablet computer, netbook computer, personal computer (PC), a desktop computer, a personal digital assistant (PDA), a smart phone, or any programmable electronic device capable of communicating with user computing device 230, and database server 250, via network 202. Host server 210 may include internal and external hardware components, as depicted, and described in further detail with reference to FIG. 1. In other embodiments, host server 210 may be implemented in a cloud computing environment, as further described in relation to FIG. 1. Host server 210 may also have wireless connectivity capabilities allowing it to communicate with user computing device 230, database server 250, and other computers or servers over network 202.

With continued reference to FIG. 2, user computing device 230 includes user interface 232, application 234, and camera 236. In various embodiments, user computing device 230 may be a laptop computer, tablet computer, netbook computer, personal computer (PC), a desktop computer, a personal digital assistant (PDA), a smart phone, a server, a wearable device, or any programmable electronic device capable of communicating with host server 210, and database server 250, via network 202. User computing device 230 may include internal and external hardware components, as depicted, and described in further detail with reference to FIG. 1. In other embodiments, user computing device 230 may be implemented in a cloud computing environment, as described in relation to FIG. 1. User computing device 230 may also have wireless connectivity capabilities allowing it to communicate with host server 210, database server 250, and other computers or servers over network 202.

In exemplary embodiments, user computing device 230 includes user interface 232, which may be a computer program that allows a user to interact with user computing device 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210.

In exemplary embodiments, user interface 232 may be a touch screen display, a visual display, a remote operated display, or a display that receives input from a physical keyboard or touchpad. In alternative embodiments, user interface 232 may be operated via voice commands or by any other means known to one of ordinary skill in the art.

In exemplary embodiments, user computing device 230 includes application 234, which may be a software program capable of being run on a user mobile device, such as user computing device 230.

In exemplary embodiments, application 234 may include, but is not limited to, an online sales website, or platform, such as e-commerce websites wherein information about the weight and size of identified items can be researched and/or sold. Further, information about the selling cost of similar items in a similar condition may be researched on e-commerce websites. Application 234 may also include a platform for a user to sell or dispose of personal belongings online.

In additional embodiments, application 234 may include websites of local vendors (e.g., movers, thrift stores, haulers, junk removal specialists, consignment stores, etc.) that can assist with recommendations for moving, selling, donating, trashing, or otherwise disposing of personal belongings.

In exemplary embodiments, user computing device 230 includes camera 236, which may include a device, hardware component, module, or subsystem capable of recording, capturing, and detecting images (e.g., furniture and personal items within a room) in a user environment, or proximity, and sending the detected data to other electronics (e.g., host server 210), components (e.g., database 252), or programs (e.g., moving cost estimator program 220) within a system such as moving cost estimator computing environment 200.

In exemplary embodiments, database server 250 includes database 252. In various embodiments, database server 250 may be a laptop computer, tablet computer, netbook computer, personal computer (PC), a desktop computer, a personal digital assistant (PDA), a smart phone, a server, or any programmable electronic device capable of communicating with host server 210, and user computing device 230, via network 202. Database server 250 may include internal and external hardware components, as depicted and described in further detail with reference to FIG. 1. In other embodiments, database server 250 may be implemented in a cloud computing environment, as described in relation to FIG. 1. Database server 250 may also have wireless connectivity capabilities allowing it to communicate with host server 210, user computing device 230, and other computers or servers over network 202.

In exemplary embodiments, database 252 may contain uploaded images from camera 236, organized according to user, location, and specific room within a house (e.g., living room, dining room, bedroom, kids' room, kitchen, and so forth). The uploaded images may include images of furniture and personal items of a user. The uploaded images may include depictions of wear and tear, discoloration of an object, user annotations, and any other visual depiction of a current state of a personal item.

While database 252 is depicted as being stored on database server 250, in other embodiments, database 252 may be stored on user computing device 230, host server 210, moving cost estimator program 220, or any other device or database connected via network 202, as a separate database. In alternative embodiments, database 252 may be comprised of a cluster or plurality of computing devices, working together, or working separately.

With continued reference to FIG. 2, host server 210 includes moving cost estimator program 220. Host server 210 may be a laptop computer, tablet computer, netbook computer, personal computer (PC), a desktop computer, a personal digital assistant (PDA), a smart phone, or any programmable electronic device capable of communicating with user computing device 230, and database server 250, via network 202.

With continued reference to FIG. 2, moving cost estimator program 220, in an exemplary embodiment, may be a computer application on host server 210 that contains instruction sets, executable by a processor. The instruction sets may be described using a set of functional modules. In exemplary embodiments, moving cost estimator program 220 may receive input from user computing device 230 and database server 250, over network 202. In alternative embodiments, moving cost estimator program 220 may be a computer application on user computing device 230, or a standalone program on a separate electronic device.

With continued reference to FIG. 1, the functional modules of moving cost estimator program 220 include receiving module 222, analyzing module 224, calculating module 226, determining module 228, and generating module 229.

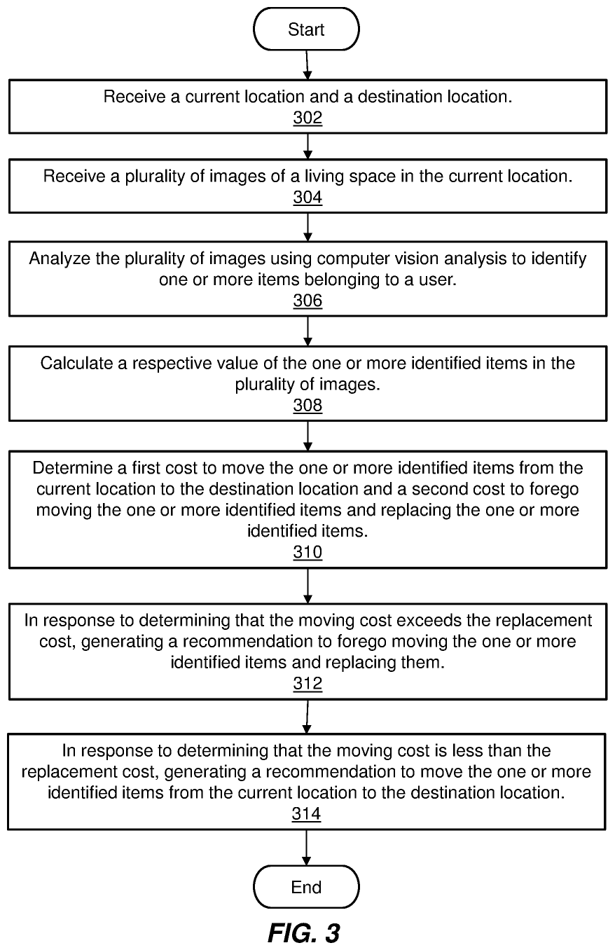

FIG. 3 is a flowchart illustrating the operation of moving cost estimator program 220 of FIG. 2, in accordance with embodiments of the present disclosure.

With reference to FIGS. 2 and 3, receiving module 222 includes a set of programming instructions, in moving cost estimator program 220, to receive a current location and a destination location (step 302). The set of programming instructions is executable by a processor.

In exemplary embodiments, a current location is the place where a user currently resides and has their possessions, such as furniture and other personal belongings. A destination location is the location where a user is moving to. When calculating a moving estimate, moving companies need to know a current location and a destination location in order to determine mileage, time required, and other logistics.

In further exemplary embodiments, if a user determines that they are going to sell some of their personal items, the prices for those various personal items may differ based on location. For example, the price for a set of ski equipment in Florida may be cheaper than a set of ski equipment in Utah, where skiing is more prevalent.

In further exemplary embodiments, receiving module 222 receives a plurality of images of a living space in the current location of the user (step 304).

In exemplary embodiments, a user captures images of their living space in a current location with their smart phone (e.g., computing device 230, camera 236) or uses 3D images of their home from the realtor.

In alternative embodiments, a user may obtain a plurality of images of their living space by any other means known to one of ordinary skill in the art.

With reference to an illustrative example, User A is moving from a cold weather location to a warm weather location. User A is stressed with the move and is concerned with the expense of the move. Luckily, User A has the assistance of moving cost estimator program 220. User A takes photographs of every room in his house with his smartphone and uploads the images to moving cost estimator program 220.

With continued reference to FIGS. 2 and 3, analyzing module 224 includes a set of programming instructions in moving cost estimator program 220, to analyze the plurality of images using computer vision analysis to identify one or more items belonging to a user (step 306). The set of programming instructions is executable by a processor.

In exemplary embodiments, analyzing module 224 uses artificial intelligence (AI) image recognition to identify items within the plurality of images. Computer vision systems use AI technology to mimic the capabilities of the human brain that are responsible for object recognition and object classification. Data scientists train computers to recognize visual data by inputting vast amounts of information. Machine learning (ML) algorithms identify common patterns in these images or videos and apply that knowledge to identify unknown images accurately. For example, if computers process millions of images of cars, they will begin to build up identity patterns that can accurately detect a vehicle in an image.

In exemplary embodiments, analyzing module 224 is capable of not only identifying furniture and personal items (e.g., couch, a bed, a dining room table, a vase, a lamp, a television, etc.) but can detect blemishes, cuts, and wear and tear on the furniture and personal items.

In further exemplary embodiments, analyzing module 224 annotates the identified one or more items to allow the user to add missing items, correct misidentified items, and remove any items owned by someone who is not moving. For example, a user may need to annotate the images to remove items in the images that belong to a roommate or a friend.

With continued reference to the illustrative example above, moving cost estimator program 220 analyzes all of User A's uploaded images and identifies every object within those images. The condition of each item is also included with the item identification. With moving cost estimator program 220, User A has the option to annotate the identified items to let the program know if an item does not belong to User A, to add missing items, and to correct misidentified items.

With continued reference to FIGS. 2 and 3, calculating module 226 includes a set of programming instructions in moving cost estimator program 220, to calculate a respective value of the one or more identified items in the plurality of images (step 308). The set of programming instructions is executable by a processor.

In exemplary embodiments, calculating module 226 searches online e-commerce websites to find similar items and to compare prices based on the condition of the items.

In exemplary embodiments, calculating module 226 searches database 252 to find the selling cost of similar items in similar condition.

In alternative embodiments, calculating module 226 uses objective data about the one or more identified items (e.g., size, weight, dimensions, etc.) to estimate the cost of moving objects from the origin location to the destination location.

In alternative embodiments, calculating module 226 searches the web for matching items (e.g., couch, mirror, bedframe, etc.) for sale from furniture stores near the destination location to estimate the cost to replace the items.

In exemplary embodiments, calculating module 226 searches the web for matching items on resale e-commerce websites to estimate the potential value of each item if sold.

In further exemplary embodiments, calculating module 226 allows the user to enter data about the one or more identified items' manufacturer, age, or model to help increase the accuracy of the resale value, if a comparable item is unable to be found on the one or more resale e-commerce websites, or if the user disagrees with the comparable matches received.

In exemplary embodiments, if a condition of the one or more identified items is unclear from the plurality of images, calculating module 226 allows the user to upload additional photographs (or images) to help determine its current condition. Alternatively, calculating module 226 allows the user to edit an assessment of the one or more identified items by rating its current condition. For example, the ratings may be: Excellent (like new), Good (minor wear and tear), Fair (expected wear and tear), or Poor (repair and restoration is required).

In alternative embodiments, calculating module 226 can look up the retail price for the one or more identified items by searching the manufacturer's website and finding the retail value of the item in brand new condition.

In exemplary embodiments, users may want to set a minimum resale value for one or more items that are greater than $0 to make it worth the effort to sell them online or through consignment.

With continued reference to the illustrative example, moving cost estimator program 220 automatically uses User A's identified items (and condition of the items) to search e-commerce websites to find out a monetary value of reselling the identified items. For example, User A's used pair of blue and white brand name cleats can be sold online for $10, while User A's two white and red printed ceramic mugs can be sold online for $3 each. Since the ceramic mugs were received by User A on his 10th wedding anniversary and hold sentimental value beyond a cost to move, User A places the mugs into the “move” category in moving cost estimator program 220, to be included with the final moving cost estimate.

With continued reference to FIGS. 2 and 3, determining module 228 includes a set of programming instructions in moving cost estimator program 220, to determine a first cost to move the one or more identified items from the current location to the destination location and a second cost to forego moving the one or more identified items and replacing the one or more identified items (step 310). The set of programming instructions is executable by a processor.

In exemplary embodiments, determining module 228 retrieves data from comparable items available for sale on one or more e-commerce websites to estimate the one or more identified items' dimensions, weight, and degree of fragility based on the retrieved data.

In exemplary embodiments, determining module 228 searches database 252 to find information about the weight and size of the one or more identified items.

In further exemplary embodiments, determining module 228 calculates a moving cost based on the one or more identified items' estimated dimensions, weight, and packing requirements with respect to the degree of fragility.

In alternative embodiments, determining module 228 determines the cost of shipping the user's items and deducts that cost from the cost of buying similar item(s) at the new home location (i.e., destination location).

In exemplary embodiments, when determining module 228 determines that the first cost to move the one or more identified items from the current location to the destination location exceeds the second cost to forego moving the one or more identified items and replacing the one or more identified items, determining module 228 determines a resale value of the one or more identified items based, at least in part, on determining a condition of the one or more identified items and retrieving values of other comparable items of similar condition available for sale on one or more resale e-commerce websites.

With continued reference to the illustrative example above, User A goes through each identified household item in moving cost estimator program 220, via a unique user interface 232, and determines whether to add each item to the “move” column, the “sell” column, the “donate” column, or the “junk” column. Luckily, User A has the assistance of moving cost estimator program 220 to assist him with making these decisions. The program makes a recommendation based on the condition of the item, the dimensions of the item which influence moving costs, and potential values of the item if the user were to sell, move, or dispose of it. For example, User A's large beige couch is 28.74″×3′×3′, weighs 156 pounds, and is in good condition. Based on this information, moving cost estimator program 220 has determined, based on online search results, that the cost to replace is between $1,410-$3,050, the sale value is $959-$1,240, the cost to move is $50-$75, and the cost to dispose is $10-$45.

With continued reference to FIGS. 2 and 3, generating module 229 includes a set of programming instructions in moving cost estimator program 220, to generate a recommendation to forego moving the one or more identified items and replacing the one or more identified items, in response to determining that the moving cost exceeds the cost of replacing the one or more identified items (step 312). Alternatively, generating module 229 generates a recommendation to move the one or more identified items from the current location to the destination location in, response to determining that the moving cost is less than the cost of replacing the one or more identified items (step 314). The set of programming instructions is executable by a processor.

In exemplary embodiments, responsive to the determined resale value of the one or more identified items being greater than a predetermined amount, generating module 229 generates a recommendation to sell the one or more identified items. A predetermined amount is fixed by the user and/or the moving company and typically equals the value of a moving cost for an item compared to a market rate replacement cost for the item. For example, if the cost to move a five year old, used couch is $350 and the replacement cost for a new couch is $3000, then generating module 229 may recommend to move the couch instead of replacing it.

In further exemplary embodiments, responsive to the determined resale value of the one or more identified items being less than a predetermined amount, generating module 229 generates a recommendation to donate or dispose of the one or more identified items.

In exemplary embodiments, if the cost to move an item is greater than the cost to replace the item, then generating module 229 may recommend a user to sell or donate the item, depending on condition and/or determined resale value.

In exemplary embodiments, if one or more items appear broken or in poor condition or not something that can be resold (e.g., cleaning products, cracked bedframe, etc.), generating module 229 recommends to user a local junk removal service.

In exemplary embodiments, generating module 229 recommends a list of the one or more identified items to ship, sell, donate, or throw away and allows the user, via a unique graphical user interface (e.g., user interface 232), to select the one or more identified items to be added to ship, sell, donate, or throw away.

In exemplary embodiments, moving cost estimator program 220 depicts a screen, via user interface 232, to upload images. User interface 232 may include another screen that requests a user's current location, destination location, contact information, expected move date, and so forth.

In further exemplary embodiments, the user interface 232 may have various alternative designs based on user preferences. For example, a banner at the top of the interface allows a user to view different information (e.g., location, photos, items to move, items to sell, items to donate, items to junk, etc.).

In additional exemplary embodiments, the unique user interface 232 may contain various windows, wherein each window depicts information that a user can use to determine whether to choose to move, sell, donate, or junk an item. For example, one window may depict the uploaded images of the one or more items in user's house. Another window focuses in on a highlighted item, depicting a description of the item, a size and weight, a condition, an estimated cost to replace the item, an estimated sale value, an estimated cost to move the item, an estimated cost to dispose of the item, and a recommendation to move, sell, donate, or junk the item. The window may also provide images of similar items for sale on e-commerce websites.

In exemplary embodiments, if generating module 229 recommends moving an item, then a third window on the unique user interface 232 may provide contact information for various local moving companies, together with contact information and ratings.

In alternative embodiments, if generating module 229 recommends selling, donating, or junking an item, then a third window on the unique user interface 232 may provide contact information for various local consignment stores, thrift stores, or junk removal companies, respectively, together with contact information and ratings for each merchant.

In further exemplary embodiments, generating module 229 recommends a list of local vendors that can help a user ship, sell, donate, or remove the one or more identified items. For example, the contact information for various local vendors is provided to user. Alternatively, generating module 229 can message one or more local vendors to contact the user with a cost estimate for services.

In further exemplary embodiments, generating module 229 may receive a confirmation (i.e., a selection) from the user for a local vendor that can help ship, donate, or remove the one or more identified items and request contact from the local vendor to help the user ship, sell, donate, or remove the one or more identified items.

In exemplary embodiments, moving cost estimator 220 displays the generated recommendations on a user's smartphone, such as user computing device 230.

In alternative embodiments, moving cost estimator 220 sends user an alert with the most economical option (e.g., move, sell, donate, or junk) for the one or more identified items.

With continued reference to the illustrative example above, moving cost estimator program 220 recommends moving User A's large beige couch to his new destination. User A has now made an informed and economical decision to approve the recommendation to move his couch. Additionally, User A has all contact information handy for local moving companies, local consignment stores, local thrift stores, and local junk removal companies. Moving has never been easier and stress-free for User A.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, user computing device 230, and database server 250.

1. A computer-implemented method for item-specific moving recommendations, comprising:
receiving a current location and a destination location;
receiving a plurality of images of a living space in the current location;
analyzing the plurality of images using computer vision analysis to identify one or more items belonging to a user;
calculating a respective value of the one or more identified items in the plurality of images;
determining a first cost to move the one or more identified items from the current location to the destination location and a second cost to forego moving the one or more identified items and replacing the one or more identified items; and
responsive to determining that the first cost exceeds the second cost, generating a recommendation to forego moving the one or more identified items and replacing the one or more identified items; or
responsive to determining that the first cost is less than the second cost, generating a recommendation to move the one or more identified items from the current location to the destination location.

2. The computer-implemented method of claim 1, further comprising:
annotating the identified one or more items to allow the user to add missing items, correct misidentified items, and remove any items owned by someone who is not moving.

3. The computer-implemented method of claim 1, wherein determining the first cost to move the one or more identified items from the current location to the destination location comprises:
retrieving data from comparable items available for sale on one or more e-commerce sites;
estimating the one or more identified items' dimensions, weight, and degree of fragility based on the retrieved data; and
calculating a moving cost based on the one or more identified items' estimated dimensions, weight, and packing requirements with respect to the degree of fragility.

4. The computer-implemented method of claim 1, wherein determining that the first cost exceeds the second cost further comprises:
determining a resale value of the one or more identified items based, at least in part, on determining a condition of the one or more identified items and retrieving values of other comparable items of similar condition available for sale on one or more resale e-commerce sites; and
responsive to the determined resale value of the one or more identified items being greater than a predetermined amount:
generating a recommendation to sell the one or more identified items; and
responsive to the determined resale value of the one or more identified items being less than the predetermined amount:
generating a recommendation to donate or dispose of the one or more identified items.

5. The computer-implemented method of claim 4, further comprising:
allowing the user to enter data about the one or more identified items' manufacturer, age, or model to help increase accuracy of the resale value, if a comparable item is unable to be found on the one or more resale e-commerce sites or if the user disagrees with the comparable matches retrieved.

6. The computer-implemented method of claim 4, further comprising:
if a condition of the one or more identified items is unclear, allowing the user to upload additional photographs to help determine its current condition or to edit an assessment of the one or more identified items by rating its current condition.

7. The computer-implemented method of claim 1, further comprising:
recommending a list of the one or more identified items to ship, sell, donate, or throw away; and
allowing the user to select the one or more identified items to be added to ship, sell, donate, or throw away.

8. The computer-implemented method of claim 1, further comprising:
recommending a list of local vendors that can help a user ship, sell, donate, or remove the one or more identified items;
receiving a confirmation from the user for a local vendor that can help ship, sell, donate, or remove the one or more identified items; and
requesting contact from the local vendor to help the user ship, sell, donate, or remove the one or more identified items.

9. A computer program product, comprising a non-transitory tangible storage device having program code embodied therewith, the program code executable by a processor of a computer to perform a method, the method comprising:
receiving a current location and a destination location;
receiving a plurality of images of a living space in the current location;
analyzing the plurality of images using computer vision analysis to identify one or more items belonging to a user;
calculating a respective value of the one or more identified items in the plurality of images;
determining a first cost to move the one or more identified items from the current location to the destination location and a second cost to forego moving the one or more identified items and replacing the one or more identified items; and
responsive to determining that the first cost exceeds the second cost, generating a recommendation to forego moving the one or more identified items and replacing the one or more identified items; or
responsive to determining that the first cost is less than the second cost, generating a recommendation to move the one or more identified items from the current location to the destination location.

10. The computer program product of claim 9, further comprising:
annotating the identified one or more items to allow the user to add missing items, correct misidentified items, and remove any items owned by someone who is not moving.

11. The computer program product of claim 9, wherein determining the first cost to move the one or more identified items from the current location to the destination location comprises:
retrieving data from comparable items available for sale on one or more e-commerce sites;
estimating the one or more identified items' dimensions, weight, and degree of fragility based on the retrieved data; and
calculating a moving cost based on the one or more identified items' estimated dimensions, weight, and packing requirements with respect to the degree of fragility.

12. The computer program product of claim 9, wherein determining that the first cost exceeds the second cost further comprises:
determining a resale value of the one or more identified items based, at least in part, on determining a condition of the one or more identified items and retrieving values of other comparable items of similar condition available for sale on one or more resale e-commerce sites; and
responsive to the determined resale value of the one or more identified items being greater than a predetermined amount:
generating a recommendation to sell the one or more identified items; and
responsive to the determined resale value of the one or more identified items being less than the predetermined amount:
generating a recommendation to donate or dispose of the one or more identified items.

13. The computer program product of claim 12, further comprising:
allowing the user to enter data about the one or more identified items' manufacturer, age, or model to help increase accuracy of the resale value, if a comparable item is unable to be found on the one or more resale e-commerce sites or if the user disagrees with the comparable matches retrieved.

14. The computer program product of claim 12, further comprising:
if a condition of the one or more identified items is unclear, allowing the user to upload additional photographs to help determine its current condition or to edit an assessment of the one or more identified items by rating its current condition.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
receiving a current location and a destination location;
receiving a plurality of images of a living space in the current location;
analyzing the plurality of images using computer vision analysis to identify one or more items belonging to a user;
calculating a respective value of the one or more identified items in the plurality of images;
determining a first cost to move the one or more identified items from the current location to the destination location and a second cost to forego moving the one or more identified items and replacing the one or more identified items; and
responsive to determining that the first cost exceeds the second cost, generating a recommendation to forego moving the one or more identified items and replacing the one or more identified items; or
responsive to determining that the first cost is less than the second cost, generating a recommendation to move the one or more identified items from the current location to the destination location.

16. The computer system of claim 15, further comprising:
annotating the identified one or more items to allow the user to add missing items, correct misidentified items, and remove any items owned by someone who is not moving.

17. The computer system of claim 15, wherein determining the first cost to move the one or more identified items from the current location to the destination location comprises:
retrieving data from comparable items available for sale on one or more e-commerce sites;
estimating the one or more identified items' dimensions, weight, and degree of fragility based on the retrieved data; and
calculating a moving cost based on the one or more identified items' estimated dimensions, weight, and packing requirements with respect to the degree of fragility.

18. The computer system of claim 15, wherein determining that the first cost exceeds the second cost further comprises:
determining a resale value of the one or more identified items based, at least in part, on determining a condition of the one or more identified items and retrieving values of other comparable items of similar condition available for sale on one or more resale e-commerce sites; and
responsive to the determined resale value of the one or more identified items being greater than a predetermined amount:
generating a recommendation to sell the one or more identified items; and
responsive to the determined resale value of the one or more identified items being less than the predetermined amount:
generating a recommendation to donate or dispose of the one or more identified items.

19. The computer system of claim 18, further comprising:
allowing the user to enter data about the one or more identified items' manufacturer, age, or model to help increase accuracy of the resale value, if a comparable item is unable to be found on the one or more resale e-commerce sites or if the user disagrees with the comparable matches retrieved.

20. The computer system of claim 18, further comprising:
if a condition of the one or more identified items is unclear, allowing the user to upload additional photographs to help determine its current condition or to edit an assessment of the one or more identified items by rating its current condition.
